(19) United States
(12) Patent Application Publication
(10) Pub. No.: US 2016/0187129 A1
(43) Pub. Date: Jun. 30, 2016

(54) MOBILE DEVICE IN-VEHICLE LOCALIZATION USING INERTIAL SENSORS

(71) Applicant: QUALCOMM Incorporated, San Diego, CA (US)

(72) Inventors: Lei Zhang, Bridgewater, NJ (US); Sichao Yang, Basking Ridge, NJ (US); Xinzhou Wu, Hillsborough, NJ (US)

(21) Appl. No.: 14/588,153

(22) Filed: Dec. 31, 2014

(51) Int. Cl. G01B 21/22; H04W 4/02

(52) U.S. Cl. CPC G01B 21/22; H04W 4/027

(57) ABSTRACT

Methods of determining a position of a mobile device in a vehicle are disclosed. An angular velocity of the vehicle, at a turning time while the vehicle is turning, may be determined according to input from an inertial sensor system of a first mobile device. A longitudinal acceleration, at the turning time, of linear acceleration along a longitudinal axis of the vehicle, may be determined according to input from the inertial sensor system. A lateral acceleration, at the turning time, of linear acceleration along a lateral axis perpendicular to the longitudinal axis, also may be determined according to input from the inertial sensor system. A first distance from the first mobile device to a rear axle of the vehicle may be calculated, based at least in part on the angular velocity, the longitudinal acceleration and the lateral acceleration.

### TECHNICAL FIELD

This disclosure relates generally to mobile devices, such as mobile phones.

### DESCRIPTION OF THE RELATED TECHNOLOGY

Detection of driver mobile device use, including texting, is generally based on the personal observations of police officers. In general, there may be little or no evidence to support such an observation. Although the mobile device may indicate when voice and text messages are sent and received, an offending driver may, for example, give the mobile device to another passenger and claim that the passenger was using the mobile device.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of determining a position of a mobile device in a vehicle. In some implementations, the method may involve determining a peak angular velocity time, while a vehicle is turning, at which a peak value of an angular velocity around a vertical axis of the vehicle occurs. The lateral axis may be perpendicular to the vertical axis and perpendicular to a longitudinal axis of the vehicle. The method may involve calculating a first time difference between the peak angular velocity time and the peak lateral acceleration time and determining, based at least in part on the time difference, whether a first mobile device is in a front area of the vehicle. In some examples, the method may involve determining whether first mobile device is in another area of the vehicle, such as a rear area of the vehicle or a middle area of the vehicle.

In some implementations, the method may involve determining the peak angular velocity time and the peak lateral acceleration time according to input from inertial sensors of the first mobile device. In some examples, determining whether the first mobile device is in the front area of the vehicle may involve determining whether the first time difference is less than 100 milliseconds. In some implementations, the first time difference may equal the peak lateral acceleration time minus the peak angular velocity time and determining whether the first mobile device is in the front area of the vehicle may involve determining whether the first time difference is positive or negative. According to some such implementations, it may be determined that the first mobile device is in the front area of the vehicle if the first time difference is positive.

In some instances, it may be determined that the first mobile device is not in the front area of the vehicle. The method may involve determining whether the first mobile device is in a back area of the vehicle or a middle area of the vehicle.

In some examples, determining whether the first mobile device is in a back area of the vehicle or a middle area of the vehicle may involve receiving a second time difference from a second mobile device. The second time difference may be a difference between a peak angular velocity time and a peak lateral acceleration time determined according to input from inertial sensors of the second mobile device. The method may involve comparing the first time difference with the second time difference.

Some or all of the methods described herein may be performed by one or more devices according to instructions (e.g., software) stored on non-transitory media. Such non- transitory media may include memory devices such as those described herein, including but not limited to random access memory (RAM) devices, read-only memory (ROM) devices, etc. Accordingly, other innovative aspects of the subject matter described in this disclosure can be implemented in a non-transitory medium having software stored thereon. For example, the software may include instructions executable by a processor for: determining a peak angular velocity time, while a vehicle is turning, at which a peak value of an angular velocity around a vertical axis of the vehicle occurs; determining a peak lateral acceleration time, while the vehicle is turning, at which a peak value of linear acceleration along a lateral axis occurs, the lateral axis may be perpendicular to the vertical axis and perpendicular to a longitudinal axis of the vehicle; calculating a first time difference between the peak angular velocity time and the peak lateral acceleration time; and determining, based at least in part on the time difference, whether a first mobile device is in a front area of the vehicle.

In some examples, the peak angular velocity time and the peak lateral acceleration time may be determined according to input from inertial sensors of the first mobile device. In some instances, determining whether the first mobile device is in the front area of the vehicle may involve determining whether the first time difference is less than 100 milliseconds. In some examples, the first time difference may equal the peak lateral acceleration time minus the peak angular velocity time. Determining whether the first mobile device is in the front area of the vehicle may involve determining whether the first time difference is positive or negative. In some implementations, it may be determined that the first mobile device is in the front area of the vehicle if the first time difference is positive.

In some instances, it may be determined that the first mobile device is not in the front area of the vehicle. The software may also include instructions executable by the processor for determining whether the first mobile device is in a back area of the vehicle or a middle area of the vehicle. In some examples, determining whether the first mobile device is in a back area of the vehicle or a middle area of the vehicle may involve: receiving a second time difference from a second mobile device, the second time difference may be a difference between a peak angular velocity time and a peak lateral acceleration time determined according to input from inertial sensors of the second mobile device; and comparing the first time difference with the second time difference.

Other innovative aspects of the subject matter described in this disclosure can be implemented in an apparatus that includes a control system. In some examples, the control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

The control system may be capable of determining a peak angular velocity time, while a vehicle is turning, at which a peak value of an angular velocity around a vertical axis of the vehicle occurs. The control system may be capable of determining a peak lateral acceleration time, while the vehicle is turning, at which a peak value of linear acceleration along a lateral axis occurs. The lateral axis may be perpendicular to the vertical axis and perpendicular to a longitudinal axis of the vehicle. The control system may be capable of calculating a first time difference between the peak angular velocity time and the peak lateral acceleration time and of determining, based at least in part on the time difference, whether a mobile device is in a front area of the vehicle. In some examples, the control system may be capable of determining whether the mobile device is in another area of the vehicle, such as a rear area of the vehicle or a middle area of the vehicle.

In some implementations, the apparatus also may include an inertial sensor system. The control system may be capable of determining the peak angular velocity time and the peak lateral acceleration time according to input from inertial sensors of the inertial sensor system. In some such examples, the apparatus may be, or may include, the mobile device.

However, in alternative implementations the apparatus may not include an inertial sensor system. Instead, the apparatus may receive input from inertial sensors of an inertial sensor system of the mobile device via an interface system. The interface system may include an interface, such as a network interface, between the control system and the inertial sensor system. According to some such implementations, the control system may reside in a server, in a laptop, in the vehicle, etc.

In some examples, determining whether the mobile device is in the front area of the vehicle may involve determining whether the first time difference is less than 100 milliseconds. In some implementations, the first time difference may equal the peak lateral acceleration time minus the peak angular velocity time and determining whether the mobile device is in the front area of the vehicle may involve determining whether the first time difference is positive or negative. According to some such implementations, it may be determined that the mobile device is in the front area of the vehicle if the first time difference is positive.

In some instances, the control system may determine that the mobile device is not in the front area of the vehicle. The control system may be capable of determining whether the apparatus is in a back area of the vehicle or a middle area of the vehicle. According to some implementations, determining whether the mobile device is in a back area of the vehicle or a middle area of the vehicle may involve receiving a second time difference from a second apparatus, the second time difference being a difference between a peak angular velocity time and a peak lateral acceleration time determined according to input from inertial sensors of the second apparatus, and comparing the first time difference with the second time difference.

Other innovative aspects of the subject matter described in this disclosure can be implemented in a method of determining a position of a mobile device in a vehicle. The method may involve determining an angular velocity of a vehicle, at a turning time while the vehicle is turning, according to input from an inertial sensor system of a first mobile device; determining a longitudinal acceleration, at the turning time, of linear acceleration along a longitudinal axis of the vehicle, according to input from the inertial sensor system; determining a lateral acceleration, at the turning time, of linear acceleration along a lateral axis perpendicular to the longitudinal axis, according to input from the inertial sensor system; and calculating a first distance from the first mobile device to a rear axle of the vehicle, based at least in part on the angular velocity, the longitudinal acceleration and the lateral acceleration.

The turning time may be a peak angular velocity time at which a peak value of an angular velocity around a vertical axis of the vehicle occurs while the vehicle is turning. The method may involve determining, based at least in part on the first distance, whether the first mobile device is in a front area of the vehicle. Some implementations may involve mapping first mobile device coordinates of the first mobile device to vehicle coordinates of a vehicle coordinate system.

In some instances it may be determined that the first mobile device is not in the front area of the vehicle. The method may involve determining whether the first mobile device is in a back area of the vehicle or a middle area of the vehicle.

According to some examples, the method may involve receiving second mobile device data from a second mobile device; determining a second distance from the second mobile device to the rear axle of the vehicle, based at least in part on the second mobile device data; and comparing the first distance with the second distance to determine relative locations of the first mobile device and the second mobile device. The second mobile device data may include inertial sensor data from an inertial sensor system of the second mobile device. In some examples, the second mobile device data may include distance data or coordinate data.

Some such methods may be performed by one or more devices according to instructions (e.g., software) stored on non-transitory media. In some examples, the software may include instructions executable by a processor for: determining an angular velocity of a vehicle, at a turning time while the vehicle is turning, according to input from an inertial sensor system of a first mobile device; determining a longitudinal acceleration, at the turning time, of linear acceleration along a longitudinal axis of the vehicle, according to input from the inertial sensor system; determining a lateral acceleration, at the turning time, of linear acceleration along a lateral axis perpendicular to the longitudinal axis, according to input from the inertial sensor system; and calculating a first distance from the first mobile device to a rear axle of the vehicle, based at least in part on the angular velocity, the longitudinal acceleration and the lateral acceleration. The software also may include instructions executable by the processor for mapping first mobile device coordinates of the first mobile device to vehicle coordinates of a vehicle coordinate system.

In some implementations, the software also may include instructions executable by the processor for determining, based at least in part on the first distance, whether the first mobile device is in a front area of the vehicle. It may, in some instances, be determined that the first mobile device is not in the front area of the vehicle. The software also may include instructions executable by the processor for determining whether the first mobile device is in a back area of the vehicle or a middle area of the vehicle.

According to some examples, the software also may include instructions executable by the processor for: receiving second mobile device data from a second mobile device; determining a second distance from the second mobile device to the rear axle of the vehicle, based at least in part on the second mobile device data; and comparing the first distance with the second distance to determine relative locations of the first mobile device and the second mobile device.

In some instances, the second mobile device data may include inertial sensor data from an inertial sensor system of the second mobile device. For example, the second mobile device data may include distance data or coordinate data.

Still other innovative aspects of the subject matter described in this disclosure can be implemented in an apparatus that includes a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

The control system may be capable of: determining an angular velocity of a vehicle, at a turning time while the vehicle is turning, according to input from an inertial sensor system of a first mobile device; determining a longitudinal acceleration, at the turning time, of linear acceleration along a longitudinal axis of the vehicle, according to input from the inertial sensor system; determining a lateral acceleration, at the turning time, of linear acceleration along a lateral axis perpendicular to the longitudinal axis, according to input from the inertial sensor system; and calculating a first distance from the first mobile device to a rear axle of the vehicle, based at least in part on the angular velocity, the longitudinal acceleration and the lateral acceleration.

In some instances, the turning time may be a peak angular velocity time at which a peak value of an angular velocity around a vertical axis of the vehicle occurs while the vehicle is turning. In some examples, the control system may be capable of mapping first mobile device coordinates of the first mobile device to vehicle coordinates of a vehicle coordinate system.

According to some implementations, the control system may be capable of determining, based at least in part on the first distance, whether the first mobile device is in a front area of the vehicle. In some examples, the control system may be capable of determining whether the first mobile device is in a back area of the vehicle or a middle area of the vehicle.

In some instances, the control system may be further capable of: receiving second mobile device data from a second mobile device; determining a second distance from the second mobile device to the rear axle of the vehicle, based at least in part on the second mobile device data; and comparing the first distance with the second distance to determine relative locations of the first mobile device and the second mobile device. In some implementations, the second mobile device data may include inertial sensor data from an inertial sensor system of the second mobile device. For example, the second mobile device data may include distance data or coordinate data.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1 shows an example of a mobile device.

FIG. 2A shows an example of mobile devices inside a vehicle.

FIG. 2B shows an alternative example of mobile devices inside a vehicle.

FIG. 3 shows an example of a vehicle making a right turn.

FIG. 4 shows another example of a vehicle making a right turn.

FIG. 5 is a graph that indicates examples of lateral acceleration values detected by inertial sensor systems of mobile devices in various locations inside a vehicle during a right turn.

FIG. 6 is a block diagram that provides an example of an apparatus that includes an inertial sensor system.

FIG. 7A is a flow diagram that provides examples of operations that involve determining a position of a mobile device in a vehicle.

FIG. 7B is a flow diagram that provides examples of additional operations that involve determining a position of a mobile device in a vehicle.

FIG. 8 shows another example of a vehicle making a right turn.

FIG. 9A is a flow diagram that shows example blocks of a method for estimating a distance from an apparatus to a rear axle of a vehicle.

FIG. 9B is a flow diagram that shows example blocks of an alternative method for determining a location of an apparatus, such as a mobile device, in a vehicle.

FIGS. 10A and 10B show examples of system block diagrams illustrating an apparatus that includes an inertial sensor system as described herein.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. In addition, it is contemplated that the described implementations may be included in or associated with a variety of electronic devices such as, but not limited to, what may be referred to herein as “mobile devices.” Such mobile devices may be (or may include), for example, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, phablets, global positioning system (GPS) receivers/navigators, cameras, digital media players (such as MP3 players), camcorders, game consoles, wrist watches, clocks, calculators, electronic reading devices (e.g., e-readers), mobile health devices, computer monitors, etc. However, other aspects of this disclosure may be implemented in other types of devises, such as vehicle components and/or devices for use in a vehicle, such as auto displays (including odometer and speedometer displays, etc.), camera view displays (such as the display of a rear view camera in a vehicle), etc. Alternative aspects of this disclosure may be implemented via one or more other devices, such as a server, e.g., according to data received from one or more mobile devices. Thus, the teachings are not intended to be limited to the implementations depicted solely in the Figures, but instead have wide applicability as will be readily apparent to one having ordinary skill in the art.

Various implementations disclosed herein may use input from sensors of a mobile device to aid in determining the location of the mobile device in a vehicle. Some implementations rely only on input from the built-in inertial sensors normally provided with a mobile device, such as accelerometers and/or gyroscopes, to detect the mobile device location(s) inside the vehicle.

Some such methods involve determining a peak angular velocity time, while a vehicle is turning, at which a peak value of an angular velocity around a vertical axis of the vehicle occurs. Such methods also may involve determining a peak lateral acceleration time, while the vehicle is turning, at which a peak value of linear acceleration along a lateral axis occurs. The peak angular velocity time and the peak lateral acceleration time may be determined according to input from inertial sensors of a mobile device. The lateral axis may be perpendicular to the vertical axis and perpendicular to a longitudinal axis of the vehicle. Such methods also may involve calculating a first time difference between the peak angular velocity time and the peak lateral acceleration time, and determining, based at least in part on the time difference, whether the mobile device is in a front area of the vehicle.

Some implementations may involve calculating a distance from a mobile device to a rear axle of the vehicle, based at least in part on angular velocity, longitudinal acceleration and lateral acceleration data obtained from an inertial sensor system of the mobile device at a time while the vehicle is turning. The time may be a time at which a peak value of an angular velocity around a vertical axis of the vehicle occurs while the vehicle is turning. Such implementations may involve determining, based on the distance from the mobile device to the rear axle, whether the mobile device is in a front area of the vehicle.

Particular implementations of the subject matter described in this disclosure can be implemented to realize one or more of the following potential advantages. By implementing such methods, evidence can be provided to support a police officer's observation of a driver's mobile device use. Moreover, such methods may provide the basis for safety features of a mobile device used inside a vehicle. For example, telephone and/or texting features of a mobile device may, in some implementations, be disabled if the mobile device is determined to be in use by a driver of the vehicle. The inertial sensors used in various implementations disclosed herein may be inertial sensors that are commonly provided with mobile devices. Some implementations disclosed herein rely only on input from the inertial sensors of a single mobile device. Therefore, such implementations provide the potential advantage of not requiring input from another device, such as a vehicle-based device or another mobile device. However, alternative implementations may involve input from more than one device, e.g., more than one mobile device.

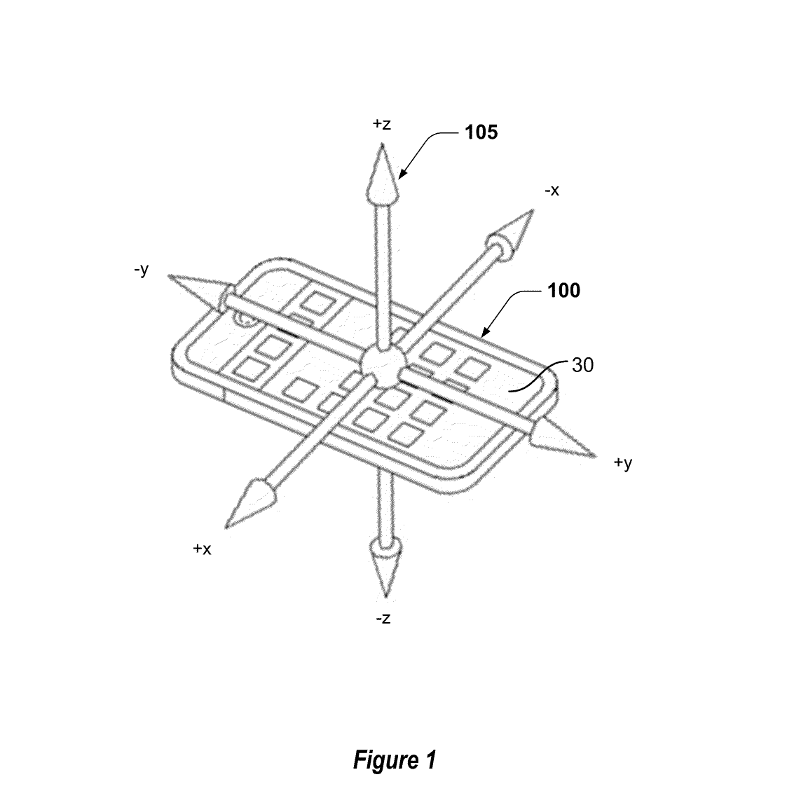

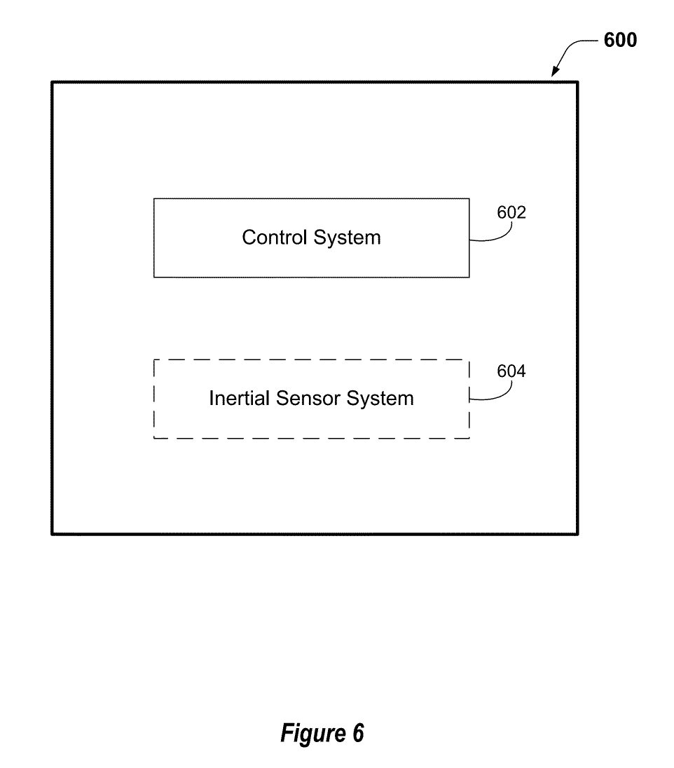

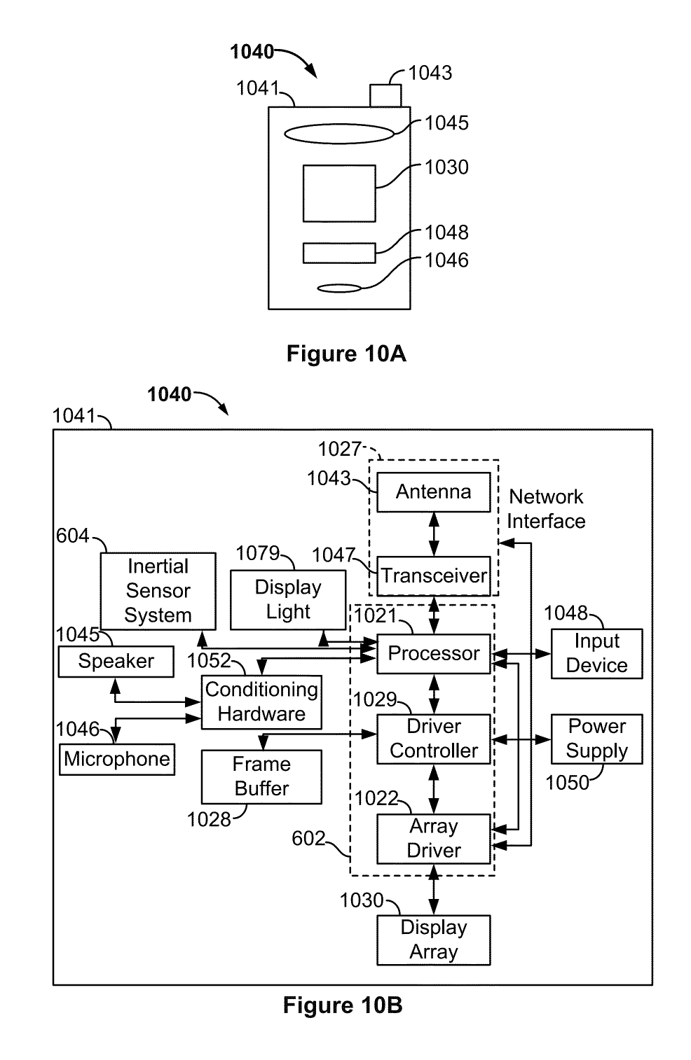

FIG. 1 shows an example of a mobile device. In this example, the mobile device 100 is a smart phone that includes an inertial sensor system. However, in alternative implementations the mobile device 100 may be another type of mobile device, such as one of the various other types of mobile devices disclosed herein. In some implementations, the inertial sensor system may be substantially similar to the inertial sensor system 604 that is shown in FIG. 6 or FIG. 10B. The inertial sensor system may, for example, include gyroscopes and accelerometers. In some examples, inertial sensor system may include gyroscopes and accelerometers configured to detect motion (including but not limited to acceleration) along three axes.

In this implementation, the mobile device 100 has an inertial sensor system that is capable of detecting motion (including but not limited to acceleration) along the x, y and z axes of the mobile device coordinate system 105 shown in FIG. 1. Here, they axis corresponds with a “long” or longitudinal axis of the mobile device 100 and the x axis corresponds with a lateral axis of the mobile device 100. In this example, the x-y plane is parallel, or substantially parallel, to the plane of the display 30. In this implementation, the z axis is a vertical axis that is perpendicular, or substantially perpendicular, to the plane of the display 30.

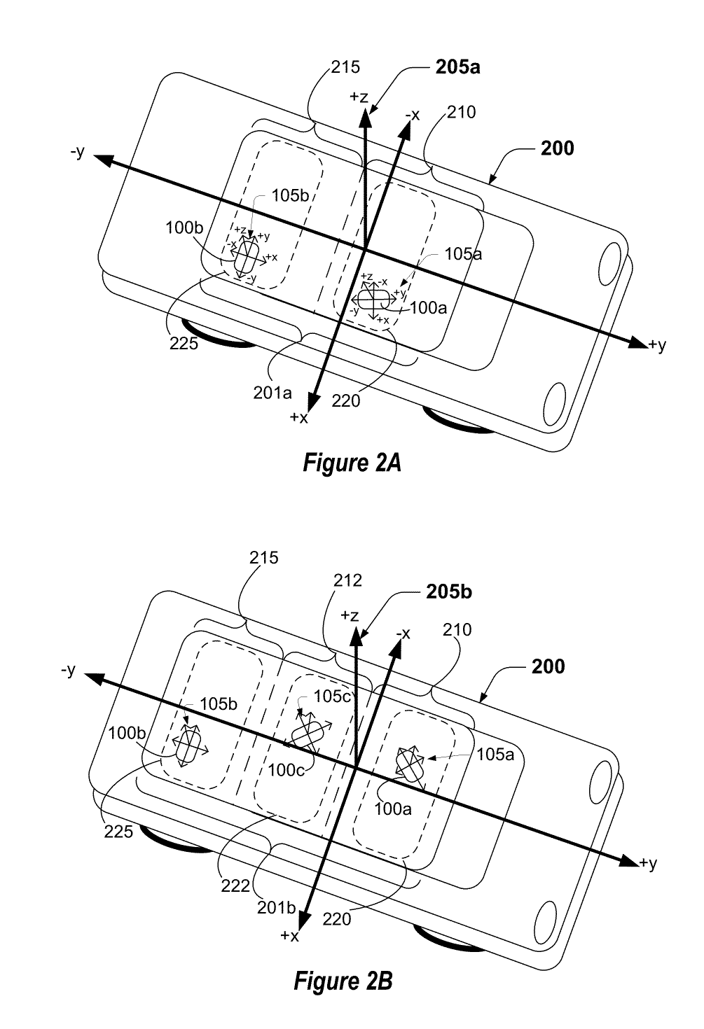

FIG. 2A shows an example of mobile devices inside a vehicle. In this example, the vehicle 200 includes a passenger compartment 201a, which has a front area 210 and a back area 215. The front area 210 includes a front seat 220 and the back area 215 includes a back seat 225. In this example, a mobile device 100a is in the front area 210 and a mobile device 100b is in the back area 215. The mobile device coordinate system 105a indicates the orientation of the mobile device 100a and the mobile device coordinate system 105b indicates the orientation of the mobile device 100b. In this example, the mobile devices 100a and 100b have different orientations.

The x, y and z axes of a vehicle coordinate system 205a are shown in FIG. 2A. Here, they axis corresponds with a longitudinal axis of the vehicle 200. In this example, the positive y direction is towards the front of the vehicle 200 and the negative y direction is towards the back of the vehicle 200. The x axis corresponds with a lateral axis of the vehicle 200. In this example, the positive x direction is towards the right of the vehicle 200 and the negative x direction is towards the left of the vehicle 200. Here, the x-y plane is parallel, or substantially parallel, to the plane of a surface on which the vehicle 200 is positioned.

FIG. 2B shows an alternative example of mobile devices inside a vehicle. In this example, the passenger compartment 201b includes a front area 210, a middle area 212 and a back area 215. The front area 210 includes a front seat 220, the middle area 212 includes a middle seat 222 and the back area 215 includes a back seat 225. In this example, a mobile device 100a is in the front area 210, a mobile device 100b is in the back area 215 and a mobile device 100c is in the middle area 212. The mobile device coordinate system 105a indicates the orientation of the mobile device 100a, the mobile device coordinate system 105b indicates the orientation of the mobile device 100b and the mobile device coordinate system 105c indicates the orientation of the mobile device 100c. In this example, the mobile devices 100a, 100b and 100c all have different orientations.

The x, y and z axes of a vehicle coordinate system 205b are substantially the same as those of the vehicle coordinate system 205b shown in FIG. 2A. However, the vehicle coordinate system 205b does not correspond with any of the mobile device coordinate systems 105a, 105b or 105c.

Accordingly, some implementations involve methods of determining an orientation of a mobile device relative to a vehicle. In some such implementations, inertial sensor measurements in a mobile device coordinate system may be expressed in a vehicle coordinate system via a mapping from the mobile device coordinate system to the vehicle coordinate system. The mapping may involve determining and applying a coordinate transformation matrix. If a mobile device is re-oriented, the coordinate transformation matrix may be updated to reflect the new mobile device orientation.

In some such implementations, the inertial sensor system of a mobile device will determine the orientation of a vehicle's longitudinal axis (the y axes of the vehicle coordinate systems 205a and 205b) according to detected acceleration and deceleration while a vehicle is driving in a straight line, or a substantially straight line. For example, when the vehicle 200 drives in a straight line along a smooth surface, all of the inertial sensor outputs may be zero, or nearly zero, except for accelerometer values along the y axis of the vehicle coordinate system 205a or 205b.

Some such implementations may involve determining the orientation of a vehicle's vertical axis (the z axes of the vehicle coordinate systems 205a and 205b) according to detected gravitational acceleration. The values of a coordinate transformation matrix may be determined based on the orientations of the vehicle's longitudinal and vertical axes.

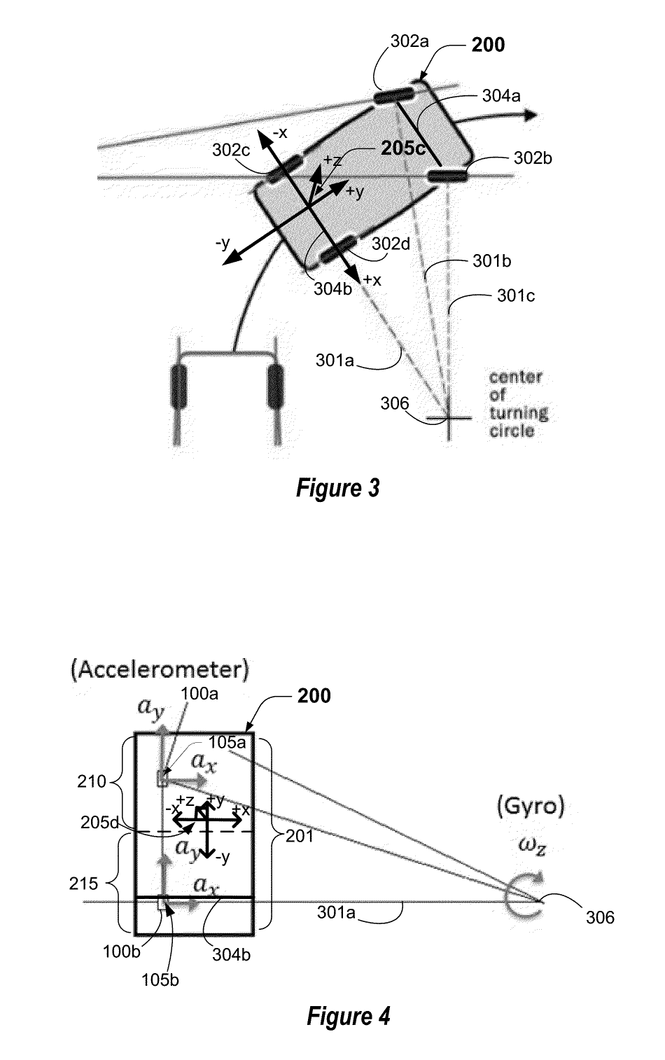

FIG. 3 shows an example of a vehicle making a right turn. Here, the wheels 302a and 302b are the front left and front right wheels, respectively, of the vehicle 200. The wheels 302a and 302b are connected by the front axle 304a. The wheels 302c and 302d are the rear left and rear right wheels, respectively. The wheels 302c and 302d are connected by the rear axle 304b.

In this example, the center of the turning circle 306 may be determined according to the intersections of two or more of the radii 301a-301c, each of which is perpendicular to at least one of the wheels 302a-302d. In this example, the wheels 302a and 302b are rotated around the z axis of the vehicle coordinate system 205c during the turn, which changes the orientation of the wheels 302a and 302b with respect to the front axle 304a. However, the wheels 302c and 302d are not rotated around the z axis of the vehicle coordinate system 205c during the turn, so that the orientation of the wheels 302c and 302d with respect to the rear axle 304b does not change during the turn. Accordingly, the rear axle 304b is disposed along the radius 301a during the turn.

Accordingly, the kinematic quantities of the vehicle 200, such as acceleration and angular velocity due to turning, can be determined by inertial sensors of one or more mobile devices 100 within the vehicle. When the vehicle 200 makes a turn, the gyroscope outputs of a mobile device corresponding to the z axis of the vehicle coordinate system 205c and the accelerometer values along the x and y axes of the vehicle coordinate system 205c may be nonzero, while other inertial sensor values may be zero, or substantially zero.

FIG. 4 shows another example of a vehicle making a right turn. In the example shown in FIG. 4, the vehicle 200 includes a passenger compartment 201, which has a front area 210 and a back area 215. In this example, a mobile device 100a is in the front area 210 and a mobile device 100b is in the back area 215. For the sake of simplicity, in FIG. 4 the axes of the mobile device coordinate systems 105a and 105b, as well as that of the vehicle coordinate system 205d, are shown as being parallel to one another.

In FIG. 4, the acceleration of each of the mobile devices along the x axis of the vehicle coordinate system 205d is depicted as a, whereas the acceleration of each of the mobile devices along they axis of the vehicle coordinate system 205d is depicted as a_{y}. The value of aₓ may sometimes be referred to herein as “lateral acceleration” or as “linear acceleration along a lateral axis of the vehicle.” The value of a_{y} may sometimes be referred to herein as “longitudinal acceleration” or as “linear acceleration along a longitudinal axis of the vehicle.”

Such accelerations may be detected by accelerometers in the inertial sensor systems of the mobile device 100a and the mobile device 100b. It may be observed that the aₓ for the mobile device 100b, in the back area 215, is substantially along a radius 301a of the center of the turning circle 306. The radius 301a is parallel, or substantially parallel, to the rear axle 304b. However, the aₓ for the mobile device 100a, in the front area 210, is not along a radius of the center of the turning circle 306. Here, the angular velocity around the z axis of the vehicle coordinate system 205d due to turning is depicted as ω_{z}, which may be detected according to gyroscope output of the inertial sensor systems.

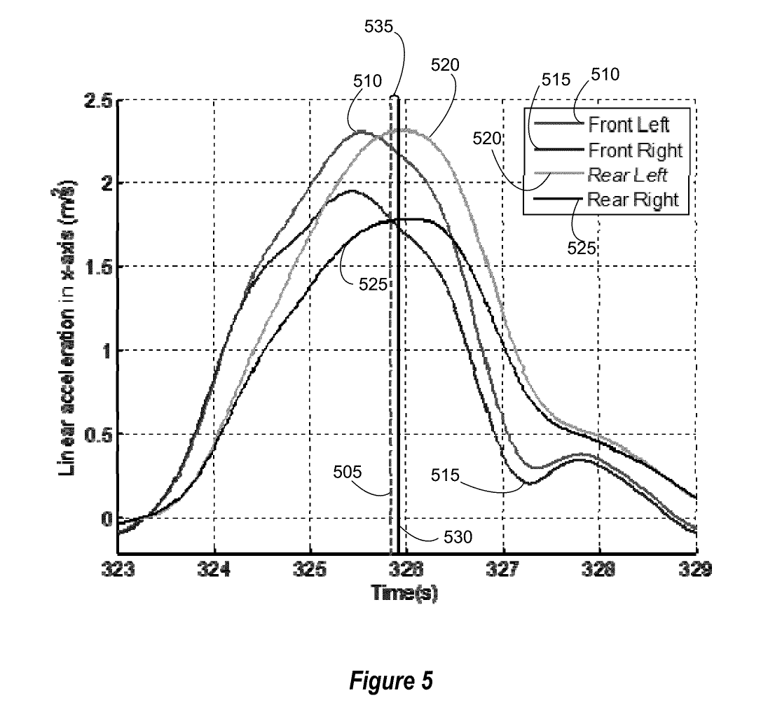

In some implementations, the shape and amplitude of the lateral acceleration aₓ can be used with reference to the maximum value of ω_{z}, to determine a mobile device's location inside a vehicle. FIG. 5 is a graph that indicates examples of lateral acceleration values detected by inertial sensor systems of mobile devices in various locations inside a vehicle during a right turn. In the graph shown in FIG. 5, the vertical axis indicates the amplitude of the lateral acceleration aₓ, expressed in m²/second, and the horizontal axis indicates time, in seconds. Here, the dashed vertical line 505 represents the time at which the peak value of the angular velocity ω_{z}, occurs. In this example, the curves 510, 515, 520 and 525 indicate the lateral acceleration aₓ detected by inertial sensor systems of mobile devices in the front left, front right, rear left and rear right of a vehicle, respectively. As shown in FIGS. 2A-4, the right side of a vehicle is in the +x direction with respect to the passenger compartment 201, whereas the left side of a vehicle is in the −x direction with respect to the passenger compartment 201. Referring to FIG. 4, for example, the mobile device 100a is in the front left of the vehicle and the mobile device 100b is in the rear left of the vehicle.

As shown in FIG. 5, when the mobile device is in the rear of the vehicle, the peak values of aₓ (shown by the curves 520 and 525) generally occur relatively closer in time to the peak value of ω_{z} than the peak values of aₓ when the mobile device is in the front of the vehicle (shown by the curves 510 and 515). Therefore, by comparing the peak values of aₓ between two mobile devices in a vehicle, it is possible to determine the positions of the mobile devices relative to one another.

Moreover, when the mobile device is on the left side of the vehicle, the detected peak amplitude of aₓ is generally larger during vehicular right turns and smaller in vehicular left turns. This may be seen in FIG. 5, wherein the curves 510 and 520, corresponding to mobile devices in the front left and rear left of the vehicle, respectively, have higher amplitudes than the curves 515 and 525, corresponding to mobile devices in the front right and rear right of the vehicle.

In addition to these relative differences in the peak values of aₓ, it may be observed that when the mobile device is in the rear of a vehicle, the peak values of aₓ and ω_{z} often occur within 100 ms of one another. For example, the curve 520 of FIG. 4, representing the values of aₓ for a mobile device in the rear left side of the vehicle, has a peak that is approximately 75 ms after the time corresponding to the peak value of ω_{z}. The time corresponding to this peak value of aₓ is shown as a solid vertical line 530. The time interval between this peak value of aₓ and the time corresponding to the peak value of ω_{z} is labeled as time interval 535 in FIG. 5. However, in alternative implementations, determining whether the first mobile device is in a front area or a rear area of a vehicle may involve determining whether the first time difference is in a different range, e.g., is less than 80 milliseconds, less than 90 milliseconds, less than 110 milliseconds, less than 120 milliseconds, less than 130 milliseconds, less than 140 milliseconds, less than 150 milliseconds, less than 160 milliseconds, less than 170 milliseconds, less than 180 milliseconds, less than 190 milliseconds, less than 200 milliseconds, etc.

When the mobile device is in the front of a vehicle, the peak values of aₓ and ω_{z} typically occur more than 100 ms apart, e.g., in the range of approximately 300 ms to 500 ms apart. In the examples shown in FIG. 5, the time difference between the peak value of ω_{z} and the peak value of aₓ detected by the mobile device in the front left of the vehicle (curve 510) is approximately 320 msec. Here, the time difference between the peak value of ω_{z} and the peak value of aₓ detected by the mobile device in the front right of the vehicle (curve 515) is approximately 400 msec. Accordingly, by obtaining inertial sensor data from a single mobile device, it may be determined whether the mobile device was in the front or the back of a vehicle during a vehicular turn.

FIG. 6 is a block diagram that provides an example of an apparatus that includes an inertial sensor system. In some examples, the apparatus 600 may be a mobile device. In this example, the apparatus 600 includes a control system 602 and an inertial sensor system 604. The inertial sensor system 604 may include inertial sensor devices such as accelerometers, gyroscopes, etc. In some implementations, the inertial sensor system 604 may include inertial sensors that are typically provided in a mobile device.

The control system 602 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. The control system 602 also may include (and/or be configured for communication with) one or more memory devices, such as one or more random access memory (RAM) devices, read-only memory (ROM) devices, etc. The control system 602 may be capable of receiving and processing inertial sensor data from the inertial sensor system 604. However, in alternative implementations the control system 602 may be capable of receiving and processing inertial sensor data from an inertial sensor system of another device. The apparatus 600 may or may not include an inertial sensor system, depending on the particular implementation. For example, in some implementations the apparatus may be a server, a laptop computer, etc.

In some implementations, the apparatus 600 may include an interface system. The interface system may include one or more wireless interfaces, one or more ports, a network interface, a user interface, etc. In some implementations of the interface system where the interface system includes a network interface, the inertial sensor system may send inertial sensor data through the interface system to a server. In such an implementation, the server may then determine, as described elsewhere herein, whether the mobile device associated with the inertial sensor system is or is not in a front area of the vehicle—or alternatively, a distance between the mobile device and the rear axle of the vehicle. The server may then, through the interface system, send an indication of whether the mobile device is in the front area of the vehicle or is not in the front area of the vehicle (or an indication of the distance between the mobile device and the rear axle). In some implementations, the interface system may include an interface between the control system and the inertial sensor system. The apparatus 600 also may include a memory system. The interface system may include an interface between the control system and the memory system. In some such implementations, the control system 602 may be capable of receiving and processing inertial sensor data from an inertial sensor system of another device, received via the interface system.

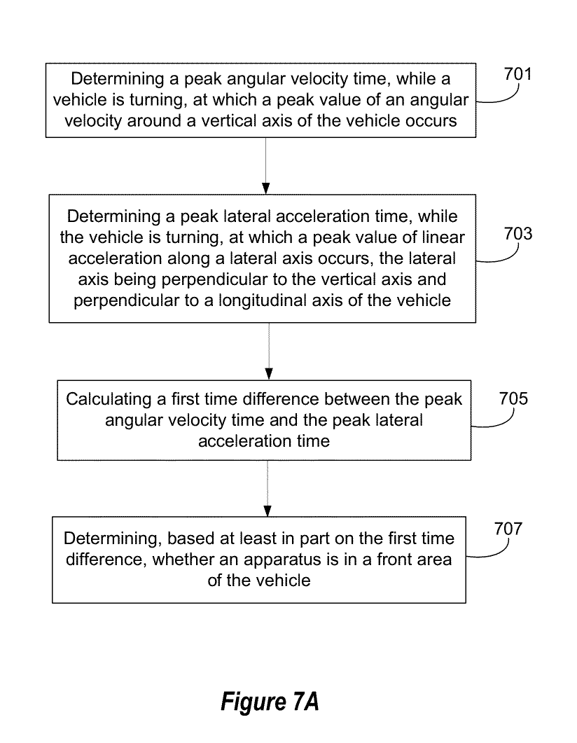

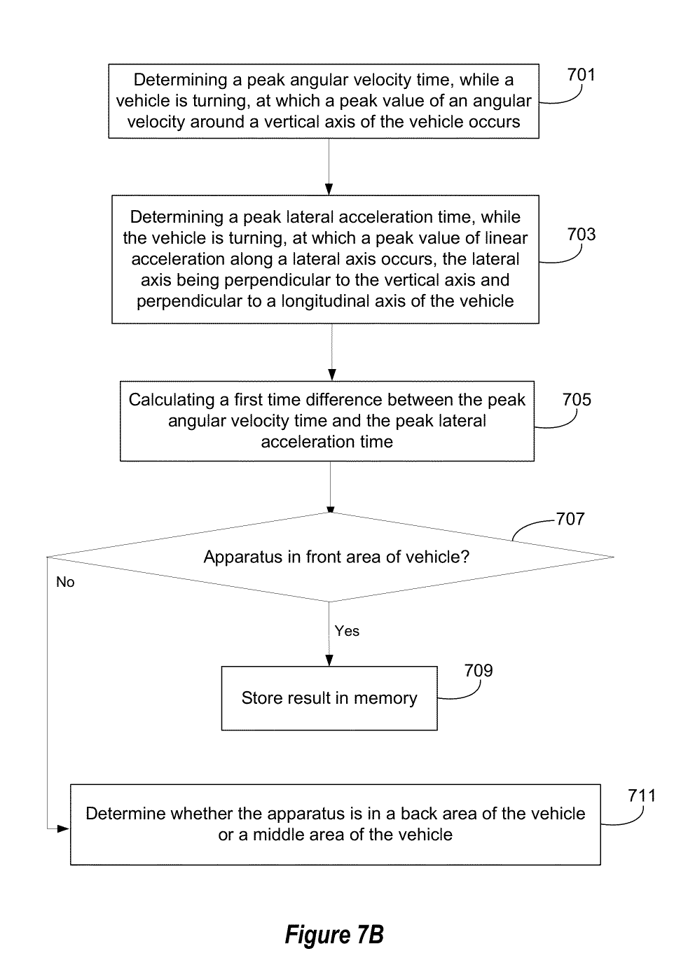

FIG. 7A is a flow diagram that provides examples of operations that involve determining a position of a mobile device in a vehicle. The blocks of FIG. 7A (and those of other flow diagrams provided herein) may, for example, be performed by a control system such as the control system 602 of FIG. 6 or by a similar apparatus. As with other methods disclosed herein, the method outlined in FIG. 7A may include more or fewer blocks than indicated. Moreover, the blocks of methods disclosed herein are not necessarily performed in the order indicated.

Here, block 701 involves determining a peak angular velocity time, while a vehicle is turning, at which a peak value of an angular velocity around a vertical axis of the vehicle occurs. For example, with a vehicle coordinate system such as shown in FIGS. 2A and 2B, the vertical axis may correspond with a z axis of the vehicle coordinate system. Therefore, the angular velocity may be expressed as ω_{z}. Accordingly, block 701 may involve determining a time at which a peak value of ω_{z} occurs.

In some implementations, block 701 may involve receiving inertial sensor data from an inertial sensor system, such as the inertial sensor system 604 shown in FIG. 6, that indicates ω_{z}. Alternatively, block 701 may involve receiving inertial sensor data from which ω_{z} may be determined. For example, the control system 602 of apparatus 600 may receive “raw” inertial sensor data from the inertial sensor system 604. The control system 602 may calculate ω_{z} based on such raw inertial sensor data.

In some examples, block 701 may involve determining the peak angular velocity time according to input from inertial sensors of a mobile device. If the mobile device coordinate system corresponds with the vehicle coordinate system, the peak angular velocity could be determined according to z-axis gyroscope output of the mobile device. However, in many instances a mobile device coordinate system will not correspond with a vehicle coordinate system. Because block 701 involves determining a peak value of an angular velocity around a vertical axis of the vehicle, which will generally not correspond with a vertical axis of a mobile device within the vehicle, block 701 may involve transforming inertial sensor data from a mobile device coordinate system to a vehicle coordinate system. For example, block 701 may involve transforming gyroscope data relative to two or more axes of the mobile device coordinate system in order to determine inertial sensor data corresponding to the z axis of the vehicle coordinate system.

In this example, block 703 involves determining a peak lateral acceleration time, while the vehicle is turning, at which a peak value of linear acceleration along a lateral axis occurs. Here, the lateral axis is perpendicular to the vertical axis and perpendicular to a longitudinal axis of the vehicle. With a vehicle coordinate system such as shown in FIGS. 2A and 2B, the vertical axis corresponds with a z axis and the longitudinal axis of the vehicle is the y axis of the vehicle coordinate system. In such a vehicle coordinate system, the lateral axis is the x axis. Accordingly, block 703 may involve determining a peak value of aₓ, the linear acceleration along the x axis.

In some examples, block 703 may involve determining the determining the peak lateral acceleration time according to input from inertial sensors of a mobile device. Accordingly, in some implementations block 703 may involve may involve transforming inertial sensor data from a mobile device coordinate system to a vehicle coordinate system. For example, block 703 may involve transforming accelerometer data relative to two or more axes of the mobile device coordinate system in order to determine linear acceleration along the x axis of the vehicle coordinate system.

In this implementation, block 705 involves calculating a first time difference between the peak angular velocity time and the peak lateral acceleration time. For example, a control system may calculate the first time difference by subtracting the peak angular velocity time from the peak lateral acceleration time, or vice versa.

Here block 707 involves determining, based at least in part on the first time difference, whether a first mobile device is in a front area of the vehicle. In this example, the first mobile device is a mobile device from which the above-referenced inertial sensor data has been obtained. As noted above, when a mobile device is in the rear of a vehicle, the peak values of aₓ and ω_{z} often occur within 100 ms of one another. Therefore, in some implementations, determining whether the first mobile device is in the front area of the vehicle may involve determining whether the first time difference is less than 100 milliseconds.

However, in alternative implementations, determining whether the first mobile device is in the front area of the vehicle may involve determining whether the first time difference is in a different range, e.g., is less than 80 milliseconds, less than 90 milliseconds, less than 110 milliseconds, less than 120 milliseconds, less than 130 milliseconds, less than 140 milliseconds, less than 150 milliseconds, less than 160 milliseconds, less than 170 milliseconds, less than 180 milliseconds, less than 190 milliseconds, less than 200 milliseconds, etc.

As noted above, when a mobile device is in the front of a vehicle, the peak values of aₓ and ω_{z} typically occur more than 100 ms apart, e.g., in the range of approximately 300 ms to 500 ms apart. Accordingly, in some implementations, determining whether the first mobile device is in the front area of the vehicle may involve determining whether the first time difference is in a different range, e.g., is more than 80 milliseconds, more than 90 milliseconds, more than 110 milliseconds, more than 120 milliseconds, more than 130 milliseconds, more than 140 milliseconds, more than 150 milliseconds, more than 160 milliseconds, more than 170 milliseconds, more than 180 milliseconds, more than 190 milliseconds, more than 200 milliseconds, more than 210 milliseconds, more than 220 milliseconds, more than 230 milliseconds, more than 240 milliseconds, more than 250 milliseconds, more than 260 milliseconds, more than 270 milliseconds, more than 280 milliseconds, more than 290 milliseconds, more than 300 milliseconds, etc. In some implementations, determining whether the first mobile device is in the front area of the vehicle may involve determining whether the first time difference between 300 and 500 milliseconds.

As shown in FIG. 5, the peak value of aₓ for mobile devices located in the front area of a vehicle tends to occur at a time that is prior to the time of the peak value of ω_{z}, whereas the peak value of aₓ for mobile devices located in the rear area of a vehicle tends to occur at a time that is after the time of the peak value of ω_{z}. Therefore, in some implementations, determining whether a first mobile device is in a front area of the vehicle may be based, at least in part, on whether the peak value of aₓ occurs at a time that is before or after the time of the peak value of ω_{z}.

For example, in some implementations, the first time difference determined in block 705 may equal the peak angular velocity time minus the peak lateral acceleration time. According to some such implementations, determining whether the first mobile device is in the front area of the vehicle may involve determining whether the first time difference is positive or negative. For example, it may be determined that the first mobile device is in the front area of the vehicle if the first time difference is positive.

FIG. 7B is a flow diagram that provides examples of additional operations that involve determining a position of a mobile device in a vehicle. Blocks 701-705 may be performed substantially as described above with reference to FIG. 7A. In the example shown in FIG. 7B, if it is determined in block 707 that the apparatus is in a front area of the vehicle, the result is stored in a memory in block 709. The memory may be a local memory of the mobile device. Alternatively, or additionally, the memory may be part of another device, such as a server and/or a device within the vehicle.

As shown in FIG. 2A, some vehicles include a middle area, which may include a middle seating area. Accordingly, in the example shown in FIG. 7B, if it is determined in block 707 that the mobile device is not in the front area of the vehicle, it is determined in block 711 whether the mobile device is in a back area of the vehicle of a middle area of the vehicle.

As noted above, when a mobile device is in the rear of a vehicle, the peak values of aₓ and ω_{z} often occur within 100 ms of one another. When a mobile device is in the front of a vehicle, the peak values of aₓ and ω_{z} typically occur more than 100 ms apart, e.g., in the range of approximately 300 ms to 500 ms apart. Inertial sensor data from a mobile device located in the middle area of a vehicle may indicate values that are intermediate between the inertial sensor data obtained from mobile devices in the front area or the rear area of vehicle.

Accordingly, in some implementations block 711 may involve determining whether the first time difference is in an intermediate time range, e.g., in a range between 100 milliseconds and 150 milliseconds, between 100 milliseconds and 200 milliseconds, between 150 milliseconds and 200 milliseconds, between 100 milliseconds and 250 milliseconds, etc.

Alternatively, or additionally, in some implementations determining whether the first mobile device is in a back area of the vehicle or a middle area of the vehicle may involve evaluating inertial sensor data from a second mobile device. Some such implementations may involve receiving a second time difference from a second mobile device. The second time difference may be a difference between a peak angular velocity time and a peak lateral acceleration time determined according to input from inertial sensors of the second mobile device. Such implementations may involve comparing the first time difference with the second time difference. For example, the second time difference may indicate that the peak values of aₓ and ω_{z} are substantially more than 100 ms apart, e.g., in the range of 300 ms to 500 ms apart, clearly indicating that the second mobile device is in a front area of the vehicle. If the first mobile device is, e.g., in the range of 150 ms to 200 ms, it may be inferred that the first mobile device is in a middle area of the vehicle.

As shown in FIG. 5, a mobile device on the left side of a vehicle will generally detect a relatively higher peak value of a, during a right turn than a mobile device on the right side of the vehicle. Accordingly, some implementations may involve comparing the amplitudes of the peak values of aₓ detected by first and second mobile devices. If the peak values are similar, the first and second mobile devices are probably on the same side of the vehicle. If the peak values are substantially different, the mobile devices are probably on different sides of the vehicle. For example, the mobile device that detected the higher peak value during a right turn is probably on the left side of the vehicle and the other mobile device is probably on the right side of the vehicle.

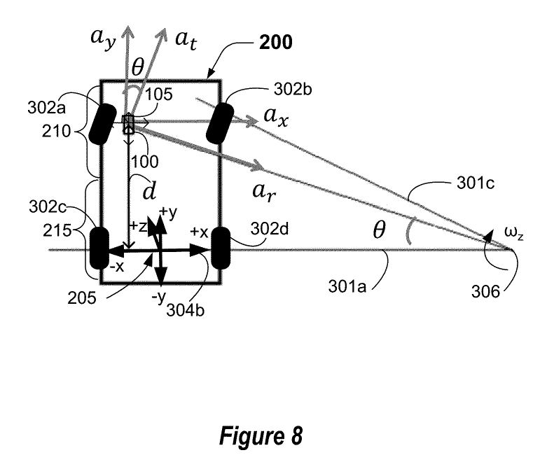

FIG. 8 shows another example of a vehicle making a right turn. In this example, a single mobile device 100, having a mobile device coordinate system 105, is shown in the left side of the front area 210 of the vehicle 200. In this example, the center of the turning circle 306 may be determined according to radii 301a and 301c, each of which is perpendicular to at least one of the wheels 302b-302d. The radius aᵣ extends from the origin of the mobile device coordinate system 105 to the center of the turning circle 306.

The radius 301a is parallel, or substantially parallel, to the rear axle 304b. FIG. 8 shows an angle θ between the rear axle 304b and the radius aᵣ. As noted above with reference to FIG. 4, the lateral acceleration aₓ of the mobile device 100 in the front area 210 is not along a radius of the center of the turning circle 306.

FIG. 8 also indicates the longitudinal acceleration a_{y} of the mobile device 100, which extends along they axis of the vehicle coordinate system 205, as well as the tangential acceleration aₜ of the mobile device 100. Here, the angular velocity around the z axis due to turning is depicted as w_{z}, which may be detected according to gyroscope output of an inertial sensor system of the mobile device 100.

Some alternative methods of determining a position of a mobile device in a vehicle involve estimating a distance from a mobile device to a rear axle of the vehicle. This distance is depicted as din FIG. 8.

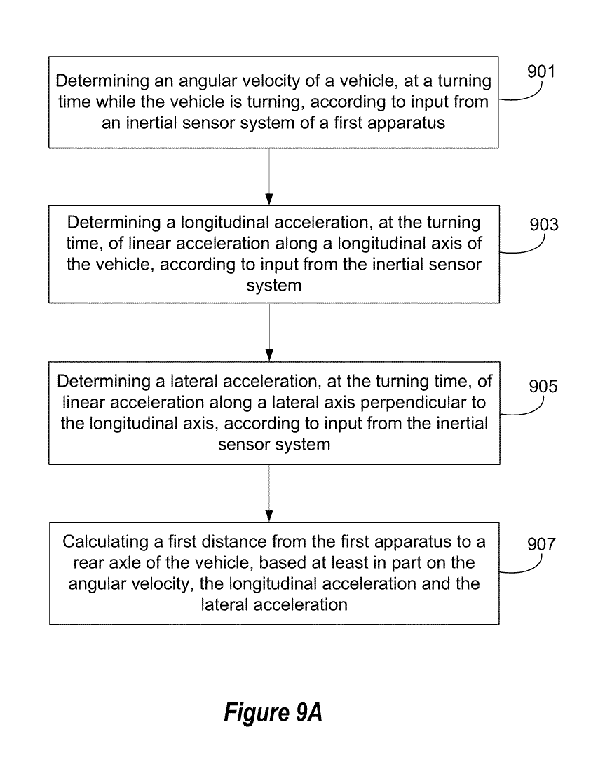

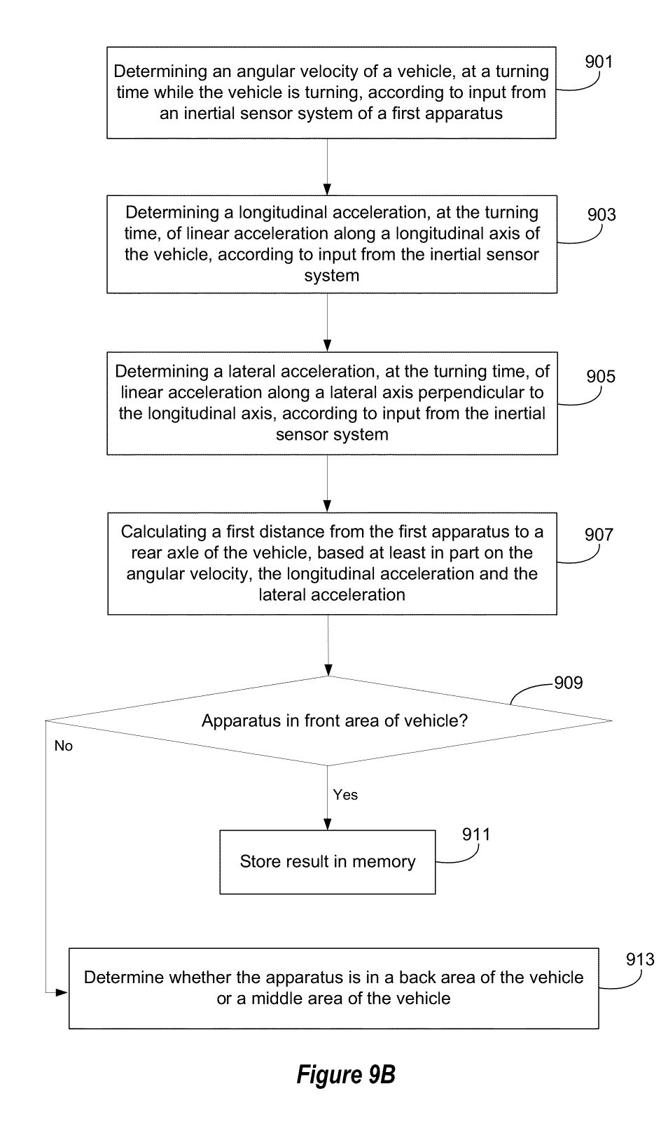

FIG. 9A is a flow diagram that shows example blocks of a method for estimating a distance from an apparatus to a rear axle of a vehicle. For example, the apparatus may be a mobile device inside the vehicle. The blocks of FIG. 9A (and those of other flow diagrams provided herein) may, for example, be performed by a control system such as the control system 602 of FIG. 6 or by a similar apparatus. As with other methods disclosed herein, the method outlined in FIG. 9A may include more or fewer blocks than indicated. Moreover, the blocks of methods disclosed herein are not necessarily performed in the order indicated.

In this implementation, block 901 involves determining an angular velocity of a vehicle, at a turning time while the vehicle is turning, according to input from an inertial sensor system of a first mobile device. In some implementations, the turning time may be a peak angular velocity time at which a peak value of an angular velocity around a vertical axis of the vehicle occurs while the vehicle is turning.

The inertial sensor system may be an inertial sensor system of a mobile device such as the mobile device 100 shown in FIG. 8. For example, with a vehicle coordinate system 205 such as shown in FIG. 8, the angular velocity of the vehicle may correspond with to w_{z}, the angular velocity with respect to the z axis of vehicle coordinate system 205. Accordingly, the method may involve mapping first mobile device coordinates of the first mobile device to vehicle coordinates of a vehicle coordinate system in order to obtain inertial sensor data with respect to the vehicle coordinate system. As shown in FIG. 8, the angular velocity of the vehicle may be with respect to a turn around the center of the turning circle 306.

In this example, block 903 involves determining a longitudinal acceleration, at the turning time, of linear acceleration along a longitudinal axis of the vehicle. For example, block 903 may involve determining a linear acceleration along they axis of the vehicle coordinate system 205. As with block 901, the longitudinal acceleration also may be determined according to input from an inertial sensor system of the first mobile device.

In this implementation, block 905 involves determining a lateral acceleration, at the turning time, of linear acceleration along a lateral axis perpendicular to the longitudinal axis, according to input from the inertial sensor system of the first mobile device. For example, block 905 may involve determining the lateral acceleration aₓ of the mobile device 100 in the vehicle coordinate system 205.

In this example, block 907 involves calculating a first distance from the first mobile device to a rear axle of the vehicle, based at least in part on the angular velocity, the longitudinal acceleration and the lateral acceleration. The distance d shown in FIG. 8 is an example of the first distance.

In some implementations, calculating the first distance from the first mobile device to the rear axle of the vehicle may involve determining an angle between the radius aᵣ, which extends from the origin of the mobile device coordinate system 105 to the center of the turning circle 306, and the rear axle 304b. One example of this angle is the angle θ shown in FIG. 8.

According to some such examples, for right turns the angle θ may be calculated by assuming that the acceleration (excluding gravity) is pointing to the center of turning circle:

aₜ=aₓ sin θ+a_{y} cos θ=0 (Equation 1)

In Equation 1, aₜ represents the tangential acceleration detected by the inertial sensor system of the mobile device, as shown in FIG. 8, aₓ represents the lateral acceleration and a_{y} represents the longitudinal acceleration.

Accordingly, the distance d from the mobile device to the rear axle 304b may be determined as follows:

aᵣ=aₓ cos θ−a_{y} sin θ=ω²d/sin θ (Equation 2)

The distance d may be calculated in a similar manner for left turns. For a left turn, φ also may be defined as the acute angle between the rear axle 304b of the vehicle 200 and a line connecting the mobile device 100 and the center of the turning circle. The angle φ may be calculated by assuming that the acceleration (excluding gravity) is pointing to the center of turning circle:

aₜ=−aₓ sin φ+a_{y} cos φ=0 (Equation 3)

Accordingly, the distance d from the mobile device to the rear axle 304b may be determined as follows:

aᵣ=−aₓ cos φ−a_{y} sin φ=ω²d/sin φ (Equation 4)

FIG. 9B is a flow diagram that shows example blocks of an alternative method for determining a location of an apparatus, such as a mobile device, in a vehicle. In this example, blocks 901-907 may be performed substantially as described above with reference to FIG. 9A.

Here, block 909 involves determining, based at least in part on the first distance from the first mobile device to the rear axle, whether the apparatus (e.g., a first mobile device) is in a front area of the vehicle. For example, block 909 may involve referring to a look-up table, or another such data structure, that includes data regarding distances from the rear axles of vehicles to the front areas of vehicles, e.g., from the rear axle to the front seat. Such information may be stored in a memory device of a mobile device, stored in a memory device of the vehicle and/or accessed from a remote storage device via a server. Such information may differ substantially according to the type of vehicle involved. For example, the front seat of a mini-van will generally be much further from the rear axle than the front seat of a small automobile. Therefore, in some implementations, a control system of an apparatus, such as a mobile device, may receive (or may have previously received) information from the user, from the vehicle or from another source, identifying the type of vehicle.

In some implementations, determining whether the apparatus is in a front area of the vehicle may involve evaluating other types of inertial sensor data from the first mobile device. For example, such implementations may involve operations such as those described above with reference to FIGS. 6-7B.

In this example, if it is determined in block 909 that the apparatus is in the front area of the vehicle, this result is stored in a memory in block 911. However, if it is determined in block 909 that the apparatus is not in the front area of the vehicle, in this example it is determined in block 913 whether the apparatus is in a back area of the vehicle or a middle area of the vehicle. In some examples block 913 may involve referencing a data structure of vehicle information, such as distances from the rear axles of vehicles to the rear areas and middle areas of vehicles, e.g., from the rear axle to the rear seat and/or the middle seat.

Alternatively, or additionally, some implementations may involve receiving second mobile device data from a second mobile device, e.g., a second mobile device within the vehicle. For example, the second mobile device data may include inertial sensor data from an inertial sensor system of the second mobile device. Alternatively, or additionally, the second mobile device data may include distance data or coordinate data. For example, if the second mobile device is also capable of determining a distance to the rear axle and/or of performing a coordinate transformation from a second mobile device reference frame to a vehicle reference frame, such data may be included in the second mobile device data.

Such implementations may involve determining a second distance from the second mobile device to the rear axle of the vehicle, based at least in part on the second mobile device data. Some such examples may involve comparing the first distance with the second distance to determine relative locations of the first mobile device and the second mobile device.

FIGS. 10A and 10B show examples of system block diagrams illustrating an apparatus that includes an inertial sensor system as described herein. The display device 1040 may be, for example, a mobile display device such as a smart phone, a cellular or mobile telephone, etc. Accordingly, in some implementations the mobile device 100 described above may be an instance of the display device 1040. Similarly, the display device 1040 may be an instance of the apparatus 600 described above. The same components of the display device 1040 or slight variations thereof are also illustrative of various types of display devices such as televisions, computers, tablets, e-readers, hand-held devices and portable media devices.

In this example, the display device 1040 includes a housing 1041, a display 1030, an antenna 1043, a speaker 1045, an input device 1048 and a microphone 1046. The housing 1041 may be formed from any of a variety of manufacturing processes, including injection molding, and vacuum forming. In addition, the housing 1041 may be made from any of a variety of materials, including, but not limited to: plastic, metal, glass, rubber and ceramic, or a combination thereof. The housing 1041 may include removable portions (not shown) that may be interchanged with other removable portions of different color, or containing different logos, pictures, or symbols.

The display 1030 may be any of a variety of displays, including a flat-panel display, such as plasma, organic light-emitting diode (OLED) or liquid crystal display (LCD), or a non-flat-panel display, such as a cathode ray tube (CRT) or other tube device. In addition, the display 1030 may include an interferometric modulator (IMOD)-based display or a micro-shutter based display.

The components of one example of the display device 1040 are schematically illustrated in FIG. 10B. Here, the display device 1040 includes a housing 1041 and may include additional components at least partially enclosed therein. For example, the display device 1040 includes a network interface 1027 that includes an antenna 1043 which may be coupled to a transceiver 1047. The network interface 1027 may be a source for image data that could be displayed on the display device 1040. Accordingly, the network interface 1027 is one example of an image source module, but the processor 1021 and the input device 1048 also may serve as an image source module. The transceiver 1047 is connected to a processor 1021, which is connected to conditioning hardware 1052. The conditioning hardware 1052 may be capable of conditioning a signal (such as applying a filter or otherwise manipulating a signal). The conditioning hardware 1052 may be connected to a speaker 1045 and a microphone 1046. The processor 1021 also may be connected to an input device 1048 and a driver controller 1029. The driver controller 1029 may be coupled to a frame buffer 1028, and to an array driver 1022, which in turn may be coupled to a display array 1030. One or more elements in the display device 1040, including elements not specifically depicted in FIG. 10B, may be capable of functioning as a memory device and be capable of communicating with the processor 1021 or other components of a control system. In some implementations, a power supply 1050 may provide power to substantially all components in the particular display device 1040 design.

In this example, the display device 1040 also includes an inertial sensor system 604. The inertial sensor system 604 may include one or more accelerometers, gyroscopes, etc. Accordingly, the inertial sensor system 604 may be capable of providing various types of inertial sensor data to the control system 602. In this example, the control system 602 includes the processor 1021, the array driver 1022 and the driver controller 1029. In some implementations, the control system 602 may be capable of determining a position of a mobile device in a vehicle, e.g., as described above with reference to FIGS. 6-9B and elsewhere in this disclosure.

The network interface 1027 includes the antenna 1043 and the transceiver 1047 so that the display device 1040 may communicate with one or more devices over a network. The network interface 1027 also may have some processing capabilities to relieve, for example, data processing requirements of the processor 1021. The antenna 1043 may transmit and receive signals. In some implementations, the antenna 1043 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 1043 transmits and receives RF signals according to the Bluetooth® standard. In the case of a cellular telephone, the antenna 1043 may be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 1047 may pre-process the signals received from the antenna 1043 so that they may be received by and further manipulated by the processor 1021. The transceiver 1047 also may process signals received from the processor 1021 so that they may be transmitted from the display device 1040 via the antenna 1043.

In some implementations, the transceiver 1047 may be replaced by a receiver. In addition, in some implementations, the network interface 1027 may be replaced by an image source, which may store or generate image data to be sent to the processor 1021. The processor 1021 may control the overall operation of the display device 1040. The processor 1021 receives data, such as compressed image data from the network interface 1027 or an image source, and processes the data into raw image data or into a format that may be readily processed into raw image data. The processor 1021 may send the processed data to the driver controller 1029 or to the frame buffer 1028 for storage. Raw data typically refers to the information that identifies the image characteristics at each location within an image. For example, such image characteristics may include color, saturation and gray-scale level.

The processor 1021 may include a microcontroller, CPU, or logic unit to control operation of the display device 1040. The conditioning hardware 1052 may include amplifiers and filters for transmitting signals to the speaker 1045, and for receiving signals from the microphone 1046. The conditioning hardware 1052 may be discrete components within the display device 1040, or may be incorporated within the processor 1021 or other components.

The driver controller 1029 may take the raw image data generated by the processor 1021 either directly from the processor 1021 or from the frame buffer 1028 and may re-format the raw image data appropriately for high speed transmission to the array driver 1022. In some implementations, the driver controller 1029 may re-format the raw image data into a data flow having a raster-like format, such that it has a time order suitable for scanning across the display array 1030. Then the driver controller 1029 sends the formatted information to the array driver 1022. Although a driver controller 1029, such as an LCD controller, is often associated with the system processor 1021 as a stand-alone Integrated Circuit (IC), such controllers may be implemented in many ways. For example, controllers may be embedded in the processor 1021 as hardware, embedded in the processor 1021 as software, or fully integrated in hardware with the array driver 1022.

The array driver 1022 may receive the formatted information from the driver controller 1029 and may re-format the video data into a parallel set of waveforms that are applied many times per second to the hundreds, and sometimes thousands (or more), of leads coming from the display's x-y matrix of display elements.

In some implementations, the driver controller 1029, the array driver 1022, and the display array 1030 are appropriate for any of the types of displays described herein. For example, the driver controller 1029 may be a conventional display controller. Additionally, the array driver 1022 may be a conventional driver. Moreover, the display array 1030 may be a conventional display array. In some implementations, the driver controller 1029 may be integrated with the array driver 1022. Such an implementation may be useful in highly integrated systems, for example, mobile phones, portable-electronic devices, watches or small-area displays.

In some implementations, the input device 1048 may be capable of allowing, for example, a user to control the operation of the display device 1040. The input device 1048 may include a keypad, such as a QWERTY keyboard or a telephone keypad, a button, a switch, a rocker, a touch-sensitive screen, a touch-sensitive screen integrated with the display array 1030, or a pressure- or heat-sensitive membrane. The microphone 1046 may be capable of functioning as an input device for the display device 1040. In some implementations, voice commands through the microphone 1046 may be used for controlling operations of the display device 1040.

The power supply 1050 may include a variety of energy storage devices. For example, the power supply 1050 may be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery may be wirelessly chargeable. The power supply 1050 also may be a renewable energy source, a capacitor, or a solar cell, including a plastic solar cell or solar-cell paint. The power supply 1050 also may be capable of receiving power from a wall outlet.

In some implementations, control programmability resides in the driver controller 1029 which may be located in several places in the electronic display system. In some other implementations, control programmability resides in the array driver 1022. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. A method of determining a position of a mobile device in a vehicle, the method comprising:
determining an angular velocity of a vehicle, at a turning time while the vehicle is turning, according to input from an inertial sensor system of a first mobile device;
determining a longitudinal acceleration, at the turning time, of linear acceleration along a longitudinal axis of the vehicle, according to input from the inertial sensor system;
determining a lateral acceleration, at the turning time, of linear acceleration along a lateral axis perpendicular to the longitudinal axis, according to input from the inertial sensor system; and
calculating a first distance from the first mobile device to a rear axle of the vehicle, based at least in part on the angular velocity, the longitudinal acceleration and the lateral acceleration.

2. The method of claim 1, wherein the turning time is a peak angular velocity time at which a peak value of an angular velocity around a vertical axis of the vehicle occurs while the vehicle is turning.

3. The method of claim 1, wherein the method further involves determining, based at least in part on the first distance, whether the first mobile device is in a front area of the vehicle.

4. The method of claim 1, wherein it is determined that the first mobile device is not in the front area of the vehicle, further comprising determining whether the first mobile device is in a back area of the vehicle or a middle area of the vehicle.

5. The method of claim 1, further comprising:
receiving second mobile device data from a second mobile device;
determining a second distance from the second mobile device to the rear axle of the vehicle, based at least in part on the second mobile device data; and
comparing the first distance with the second distance to determine relative locations of the first mobile device and the second mobile device.

6. The method of claim 5, wherein the second mobile device data comprises inertial sensor data from an inertial sensor system of the second mobile device.

7. The method of claim 5, wherein the second mobile device data comprises distance data or coordinate data.

8. The method of claim 1, further comprising mapping first mobile device coordinates of the first mobile device to vehicle coordinates of a vehicle coordinate system.

9. A non-transitory medium having software stored thereon, the software including instructions executable by a processor for:
determining an angular velocity of a vehicle, at a turning time while the vehicle is turning, according to input from an inertial sensor system of a first mobile device;
determining a longitudinal acceleration, at the turning time, of linear acceleration along a longitudinal axis of the vehicle, according to input from the inertial sensor system;
determining a lateral acceleration, at the turning time, of linear acceleration along a lateral axis perpendicular to the longitudinal axis, according to input from the inertial sensor system; and
calculating a first distance from the first mobile device to a rear axle of the vehicle, based at least in part on the angular velocity, the longitudinal acceleration and the lateral acceleration.

10. The non-transitory medium of claim 9, wherein the turning time is a peak angular velocity time at which a peak value of an angular velocity around a vertical axis of the vehicle occurs while the vehicle is turning.

11. The non-transitory medium of claim 9, wherein the software further includes instructions executable by the processor for determining, based at least in part on the first distance, whether the first mobile device is in a front area of the vehicle.

12. The non-transitory medium of claim 11, wherein it is determined that the first mobile device is not in the front area of the vehicle, and wherein the software further includes instructions executable by the processor for determining whether the first mobile device is in a back area of the vehicle or a middle area of the vehicle.

13. The non-transitory medium of claim 9, wherein the software further includes instructions executable by the processor for:
receiving second mobile device data from a second mobile device;
determining a second distance from the second mobile device to the rear axle of the vehicle, based at least in part on the second mobile device data; and
comparing the first distance with the second distance to determine relative locations of the first mobile device and the second mobile device.

14. The non-transitory medium of claim 13, wherein the second mobile device data comprises inertial sensor data from an inertial sensor system of the second mobile device.

15. The non-transitory medium of claim 13, wherein the second mobile device data comprises distance data or coordinate data.

16. The non-transitory medium of claim 9, wherein the software further includes instructions executable by the processor for mapping first mobile device coordinates of the first mobile device to vehicle coordinates of a vehicle coordinate system.

17. An apparatus comprising a control system that is capable of:
determining an angular velocity of a vehicle, at a turning time while the vehicle is turning, according to input from an inertial sensor system of a first mobile device;
determining a longitudinal acceleration, at the turning time, of linear acceleration along a longitudinal axis of the vehicle, according to input from the inertial sensor system;
determining a lateral acceleration, at the turning time, of linear acceleration along a lateral axis perpendicular to the longitudinal axis, according to input from the inertial sensor system; and
calculating a first distance from the first mobile device to a rear axle of the vehicle, based at least in part on the angular velocity, the longitudinal acceleration and the lateral acceleration.

18. The apparatus of claim 17, wherein the turning time is a peak angular velocity time at which a peak value of an angular velocity around a vertical axis of the vehicle occurs while the vehicle is turning.

19. The apparatus of claim 17, wherein the control system is capable of determining, based at least in part on the first distance, whether the first mobile device is in a front area of the vehicle.

20. The apparatus of claim 17, wherein the control system is capable of determining whether the first mobile device is in a back area of the vehicle or a middle area of the vehicle.

21. The apparatus of claim 17, wherein the control system is further capable of:
receiving second mobile device data from a second mobile device;
determining a second distance from the second mobile device to the rear axle of the vehicle, based at least in part on the second mobile device data; and
comparing the first distance with the second distance to determine relative locations of the first mobile device and the second mobile device.

22. The apparatus of claim 21, wherein the second mobile device data comprises inertial sensor data from an inertial sensor system of the second mobile device.

23. The apparatus of claim 21, wherein the second mobile device data comprises distance data or coordinate data.

24. The apparatus of claim 17, wherein the control system is capable of mapping first mobile device coordinates of the first mobile device to vehicle coordinates of a vehicle coordinate system.

25. The apparatus of claim 17, wherein the control system includes one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

26. An apparatus comprising control means for:
determining an angular velocity of a vehicle, at a turning time while the vehicle is turning, according to input from an inertial sensor system of a first mobile device;
determining a longitudinal acceleration, at the turning time, of linear acceleration along a longitudinal axis of the vehicle, according to input from the inertial sensor system;
determining a lateral acceleration, at the turning time, of linear acceleration along a lateral axis perpendicular to the longitudinal axis, according to input from the inertial sensor system; and
calculating a first distance from the first mobile device to a rear axle of the vehicle, based at least in part on the angular velocity, the longitudinal acceleration and the lateral acceleration.

27. The apparatus of claim 26, wherein the turning time is a peak angular velocity time at which a peak value of an angular velocity around a vertical axis of the vehicle occurs while the vehicle is turning.

28. The apparatus of claim 26, wherein the control means includes means for determining, based at least in part on the first distance, whether the first mobile device is in a front area of the vehicle.

29. The apparatus of claim 26, wherein the control means includes means for determining whether the first mobile device is in a back area of the vehicle or a middle area of the vehicle.

30. The apparatus of claim 26, wherein the control means further includes means for:
receiving second mobile device data from a second mobile device;
determining a second distance from the second mobile device to the rear axle of the vehicle, based at least in part on the second mobile device data; and
comparing the first distance with the second distance to determine relative locations of the first mobile device and the second mobile device.
